(19) United States
(12) Patent Application Publication
(10) Pub. No.: US 2024/0060597 A1
(43) Pub. Date: Feb. 22, 2024

(54) FREESTANDING BASE AND SHAFT

(71) Applicant: Tracy Lynn Grosskopf, Santa Clarita, CA (US)

(72) Inventor: Tracy Lynn Grosskopf, Santa Clarita, CA (US)

(21) Appl. No.: 18/232,349

(22) Filed: Aug. 9, 2023

Related U.S. Application Data
(60) Provisional application No. 63/371,620, filed on Aug. 16, 2022.

(51) Int. Cl. F16M 11/22; F21S 9/03; F21S 8/08

(52) U.S. Cl. CPC F16M 11/22; F21S 9/03; F21S 8/08

(57) ABSTRACT

A freestanding base and shaft for solar lights and other products which can be used in multiple areas at multiple and interchangeable heights and on multiple surfaces and which can be enhanced with decorative options for the user. Adjustable heights for different conditions and various placement offers solar products more options and unlimited applications. Functional use lighting for pathways and other areas can be placed on a variety of ground surfaces and at multiple levels and can be adjusted or moved for changing conditions. Lighting can be added to stairs or illuminate other areas where tripping hazards may exist. The mobility of these items offers the user the option of moving the lights and products to storage in unfavorable conditions. In one embodiment, such products may only be used temporarily as supplemental lighting and as decorative additions when desired.

This patent application claims priority to U.S. Provisional Patent Application 63/371,620 Filed on Aug. 16, 2022, which is incorporated by reference herein in its entirety.

### BACKGROUND OF THE SYSTEM

The typical outdoor solar light and many other solar products come in limited heights and often standard black coloring. They have no ornamental options and commonly include a short plastic stake on which to mount the product. The included plastic stake can be unreliable in use. The stake is somewhat flexible and often bends during insertion into firmer soil. The stake is difficult to insert fully into the ground, so the solar products are prone to tilting, falling, and instability. Many times, the stake breaks during insertion, rendering the product unusable.

In addition, the nature of the stake means that the solar products and are often accidentally broken, kicked or otherwise hit during normal gardening tasks, requiring the user to replace that piece or the entire product kit at additional expense. Plastic, metal and other stakes also limit the placement and use of solar lights and other products. Soil can be too hard, rocky, or otherwise limiting for use of the stake and the option of using the products on a solid surface is unavailable. These items are often disposed of when conditions change and are replaced annually or more frequently because the stake can be difficult to remove. The plastic stake often remains in the ground which is an environmental concern. In addition, placement of the products with stakes is limited to areas of soil. A user may want to use the solar products on concrete or other hard surfaces.

### SUMMARY

A freestanding base and shaft for solar lights and other products which can be used in multiple areas at multiple and interchangeable heights and on multiple surfaces and which can be enhanced with decorative options for the user. Adjustable heights for different conditions and various placement offers solar products more options and unlimited applications. Functional use lighting for pathways and other areas can be placed on a variety of ground surfaces and at multiple levels and can be adjusted or moved for changing conditions. Lighting can be added to stairs, balconies, decks, docks, tabletops, and the like or illuminate other areas where tripping hazards may exist or where prior art solar products are not usable. The mobility of these items offers the user the option of moving the lights and products to storage in unfavorable conditions. In one embodiment, such products may only be used temporarily as supplemental lighting and as decorative additions when desired. The addition of decorative features allows the solar lights and products numerous additional applications.

### BRIEF DESCRIPTION OF THE DRAWINGS

FIG. 1 illustrates an embodiment of the apparatus.

FIG. 2 illustrates another embodiment of the apparatus.

FIG. 3 illustrates another embodiment of the apparatus with a rotating base.

FIG. 4 illustrates an embodiment of the apparatus for receiving a solar product.

FIG. 5 illustrates the connection of the shaft to a conical base in an embodiment.

### DETAILED DESCRIPTION OF THE SYSTEM

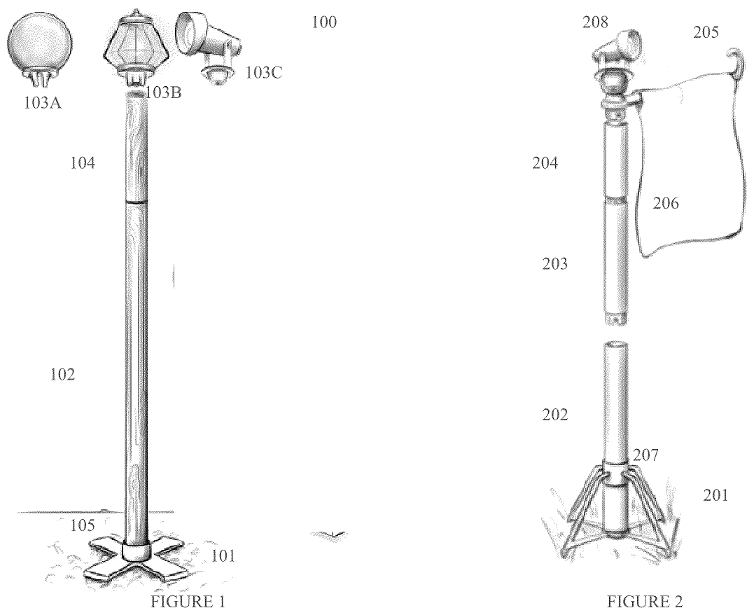

The apparatus, in one embodiment, comprises a base, shaft, and attachment means for a solar product or other lighting or decorative element. Referring to FIG. 1, the device 100 comprises base 101, shaft 102, solar product attachments 103A, 103B, and 103C, and extension member 104. The base 101 may be a cross as shown in FIG. 1, or it may be round, oval, square, triangular, rectangular, or any suitable shape to provide stability to the shaft and any extensions that may be used.

In one embodiment, the shaft 102 engages a holder 105 in the base which may be a threaded female member that receives a threaded male portion of shaft 102. In one embodiment, the bottom of the shaft 102 is a threaded female member that engages a threaded male member on the base to securely hold the shaft in place. In one embodiment the shaft may engage the holder 105 with a pressure fit, set screw, or any other suitable means. The ability to securely join the different parts of the apparatus allows the apparatus to be easily moved without compromising the integrity of the apparatus

Shaft 102 may directly receive a solar product 103A-C. Alternatively, shaft 102 may have an extension 104 that in turn receives and holds a solar product 103A-C. In this manner the position of the solar product may be higher or lower as desired.

In one embodiment the shaft may be comprised of multiple portions (e.g., 102 and 104) or it may be a telescoping shaft that can be elongated to different lengths as desired.

FIG. 2 illustrates another embodiment of the apparatus. FIG. 2 illustrates a different base 201 that includes a plurality of legs that are coupled to a ring 207 that receives lower shaft member 202. Shaft extensions 203 and 204 may be added as desired to control the height of the solar product 208 mounted to the apparatus.

A horizontal arm 205 can be mounted at the top of any of the shaft members and is held in place by either another shaft member or by the solar product engaging the uppermost shaft region. Horizontal arm 205 can be used to display one or more removable flags (e.g., flag 206). In one embodiment, multiple horizontal arms may be deployed as desired.

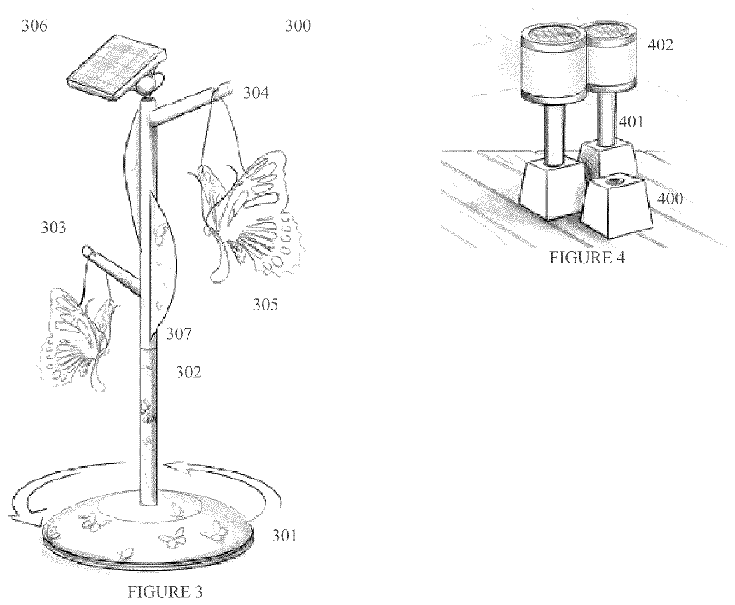

FIG. 3 illustrates another embodiment of the apparatus. The apparatus 300 comprises a base 301 and shaft 302. The base 301 is a domed base that can rotate for customized positioning of the apparatus 300. The shaft 302 includes protruding members 303 and 304 for receiving decorative items (e.g. butterflies 305). A solar product 306 may be affixed to the top of the shaft. In one embodiment, a solar panel 306 is coupled to the shaft and powers a motor in the base 301 which causes rotation of the base and apparatus, adding to the enjoyment of the device. In one embodiment, a fan 307 is coupled to the shaft 302. The fan can 307 cause the base to turn in response to wind blowing on the device, or the base can be motorized and powered by the solar product in one embodiment.

The devices can be comprised of metal, plastic, wood, and the like, and may be solid, patterned, or decorated as desired.

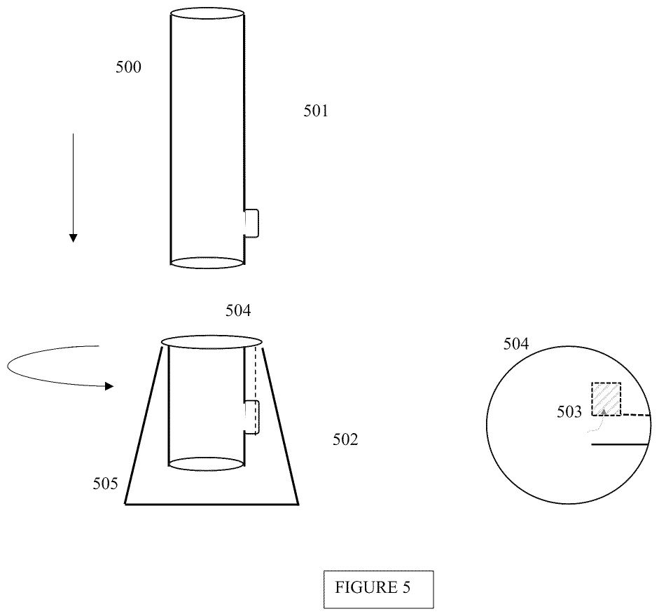

FIG. 4 illustrates an embodiment for directly replacing the stake of a standard garden solar product. The device 400 is a tapered block structure with a circular opening in the top thereof for receiving the shaft 401 of a solar product 402. The opening has a diameter large enough to accommodate the majority of off the shelf solar products. The use of the block 400 allows the easy placement of the solar product without the use of the stakes, and permits placement on any surface, including soil, lawn, sidewalks, steps, and the like. In one embodiment, the block 400 is of sufficient weight to resist overturning during use or from wind. The base may be larger than the top to lower the center of gravity and increase stability. In one embodiment, the base is a truncated pyramid. In one embodiment, the base is a truncated cone.

FIG. 5 illustrates the connection of the shaft 500 to a truncated cone or truncated pyramid base 505 in an embodiment. In one embodiment, the shaft 500 includes a nub 501 that engages a slot 503 in the otherwise circular opening 504 of base 505. Once inserted, the shaft is rotated into a slot lock 503 that retains the shaft in place. It should be understood that other mechanisms may be used to hold the shaft 500 in place in the base 505.

What is claimed is:

1. An apparatus for supporting a solar product comprising:
a base;
a shaft having a first and second end and coupled to the base at the first end, the shaft having an attachment means at the second end;
a solar product coupled to the attachment means.

2. The apparatus of claim 1 wherein the shaft is removably coupled to the base.

3. The apparatus of claim 1 wherein the solar product is removable coupled to the attachment means.

4. The apparatus of claim 1 wherein the base comprises a cross member.

5. The apparatus of claim 1 wherein the base comprises a plurality of legs.

6. The apparatus of claim 1 wherein the base comprises a truncated pyramid.

7. The apparatus of claim 1 wherein the base comprises a truncated cone.

8. The apparatus of claim 1 wherein the base comprises a rotating member.

9. The apparatus of claim 1 wherein the shaft further includes a plurality of arms.
